(19) United States
(12) Patent Application Publication
(10) Pub. No.: US 2006/0085431 A1
(43) Pub. Date: Apr. 20, 2006

(54) Systems and methods for protecting private electronic data

(76) Inventors: David M. Burns, Holliston, MA (US); Mark L. Woodward, Milton, MA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 11/249,045

(22) Filed: Oct. 12, 2005

Related U.S. Application Data
(60) Provisional application No. 60/618,109, filed on Oct. 13, 2004.

(51) Int. Cl. G06F 17/30

(52) U.S. Cl. 707/10

(57) ABSTRACT

Described herein are methods and systems for choosing digital advertisements to send to a user's computer while protecting private information. When a user performs a search using a public site, the user's search information is stored in a database. The system builds a profile for the user based on the public search information, which can be used to select advertisements for delivery to the user's computer. The system can also select advertisements based on information gleamed from a user's private (desktop) searches. For example, the system can use the category in which a user is searching to chose advertisements.

### CROSS-REFERENCE TO RELATED APPLICATIONS

This application claim priority to U.S. Provisional Patent Application Ser. No. 60/618,109, entitled “A System For Monetizing the Search of Private Desktop Content Based on Algorithmic Analysis of Public Web Search Terms,” filed Oct. 13, 2004, hereby incorporated by reference in its entirety.

### BACKGROUND OF THE INVENTION

Personal computer users are increasingly coming to accept and, indeed, welcome advertising on the computer “desktops” in exchange for quality software packages that are otherwise free (or inexpensive) to install. Software publishers are embracing this model, too, since advertising revenues can more then compensate publishers for their efforts in producing such software. A tool to improving those revenues is to insure that advertisements are targeted to users most likely to purchase the advertised goods.

Opt-in software that permits users to make specific designations of types of advertisements they are willing to accept has a low take rate, usually in the single digits. Hence, software publishers who are interested in taking advantage of this new software distribution model are forced to fall back more heavily on more traditional keyword-based systems that target advertising based on search terms entered by users in web browsers or desktop search programs. However, such search terms (or keywords) can prove a poor basis for targeting advertising since they are often so user-specific as to prove essentially ambiguous from the advertiser's perspective.

In addition, over the last few months we have seen many privacy issues arise with such keyword-based systems, both domestically and internationally. For example, the portal Google received bad press with its new mail package, because users quickly figured out that Google was reading their mail in order to extract the most relevant keywords to base ads on. In this particular case, the privacy violation was not even as serious as it might have been, since the Google ad server is most likely place in the same private data center, and on the same private intranet as the e-mail servers. What it means to users, is that their email is being read, and keywords are being extracted from it and used to select ads. At least Google has its own ad server, and therefore is not sending keywords extracted from the user's private email out over the public internet However, this is not the case with other conventional ad programs.

We have also read many articles and have heard much feedback from users, which goes along the following lines, “We don't mind if you send our search terms of the public Web over the public Internet to an ad server in order to bring back both Web search results and sponsored links. However, we have a big problem if you, in any way, shape or form, send the search terms for our private desktop content, or terms extracted from our private desktop content, over the public Internet.”

It turns out that users are extremely protective of the private content stored on their PC hard drive, on private networks, or found on password-protected internet sites. Internet and computer users prefer to remain unanimous, and are adamant that search terms used in conjunction with their private desktop content, must never be sent out over the public Internet, either for the purposes of fetching an ad or for any other purposes, such as transfer to a central site for group behavior modeling.

In addition, feedback from users strongly suggests that they don't want anybody or any company reading their private e-mails and files, or for that matter any of their private content. They especially don't want any of their personal information sent to any central location for the purpose of serving higher-quality advertising based in some way on searches of their private desktop. They don't want “big brother” tracking what they type into the URL address bar, or tracking what ads they click on, or recording the words in ads they click on, or tracking what particular web site they click on in their search results. And of course, they don't want pop-ups, popovers, pop-unders, Trojan horses, time bombs, etc.

In view of the foregoing, an object of this invention is to provide improved methods and apparatus of digital data processing

A related object of the invention is to provide improved methods and apparatus for targeting advertising to computer users.

A still further related object of the invention is to provide such methods and apparatus as limit exposure of private user information.

### SUMMARY OF THE INVENTION

The invention meets the aforementioned objects, among others, by providing inter alia methods and systems for choosing digital advertisements to send to a user's computer, while protecting the user's private information.

Systems according to some such aspects of the invention distinguish between public search information (e.g., search terms used in a web based search engine) and private search information. Thus, in one aspect, such a system uses public search information to chose advertisements based on the relevancy, frequency, and/or affinity of public search terms. Private search information can also be used, however the system does not send private information across the world wide web. For example, instead of sending out private search terms, the system can match private search terms to category codes and send the category codes to an advertisement server.

In a related aspect of the invention, a system according to the invention includes a user's computer (e.g., personal computer, laptop computer or other suitable digital data device) connected to the world wide web, a digital data sever connected to (i.e., in communication with) the user's computer through the world wide web, and an advertisement server. The user's computer is adapted to recognize and collect public search terms entered into a public search program through the user's computer, the user's computer also includes a database of the collected public search term. The database can also include a list of category codes that correspond to private search terms. The digital data server is adapted to receive public search terms and/or category codes from the database and the advertisement server is adapted to choose and send ads to the user's computer based on received public search terms and/or category codes.

In one aspect, the database stores information on the location at which the desktop search program was obtain and information on the time of day at which the public search terms where entered into the public search program. The system can use this information to rank the public search terms according to relevancy, frequency, and/or affinity and send the highest ranking search terms to the advertisement server.

In another aspect, the system can use the private search terms collected in the database to select advertisements. For example, the system can send category codes that correspond to the private search terms to the advertisements server. The advertisement server can then chose advertisements based on the category in which the user is searching. To assist with choosing advertisements, the advertisement server can include a database containing category codes and digital advertisements corresponding to the category codes.

In another aspect, the invention provides a method for selecting digital advertisements, while privatizing personal information, is disclosed. The method includes the steps of collecting and storing, with a digital data processor, public search terms entered by a user into an internet based search program and date and time information corresponding to the public search terms. The method can further include ranking the search terms according to relevancy, frequency, and/or affinity based on the collected information. Advertisements can be sent, with an advertisement server, to the user's computer based on the highest ranking search terms.

In another aspect, the method further includes the step of collecting and storing, in a computer database, private search terms entered by a user into a desktop search program. By matching the private search terms to category codes and sending the matched category codes to the advertisement server, advertisements can be selected without violating a user's privacy. In addition, or alternatively, the method can include the step of matching a type of program used by the user to a category codes and sending the matched category code to the advertisement server.

In another aspect of the invention, a method for sending digital advertisements to a user's computer without revealing private information is disclosed. The method includes storing, in a computer database, public search terms entered by a user into an internet based search program and storing date and time information corresponding to the public search terms. In addition, private search terms entered by a user into a desktop search program are stored in the database. The method further includes matching the private search terms with category codes. The matched category codes are then sent to an advertisement server, which can chose advertisements based on the received category code.

### Brief Description of the Drawings

The foregoing features, objects and advantages of the invention will become apparent to those skilled in the art from the following detailed description of a preferred embodiment, especially when considered in conjunction with the accompanying drawings.

FIG. 1 is a schematic diagram of one embodiment of the system described herein showing a user's computer connected, via the world wide web, to a digital data server and an advertisement server; and

FIG. 2 is a flow chart illustrating one embodiment of the algorithm used to select advertisements based on time behavior, recency, and/or frequency.

### DETAILED DESCRIPTION

Described herein are various embodiments of the Privacy First system. The system can monitor search terms entered into search programs, such as public search programs (e.g., Google) and private search programs (e.g., Copernic Desktop Search (“CDS”)) to serve the most relevant ads to a user without violating the user's privacy. Private content is described for the purposes of this document as data in which a user would have some expectation of privacy (i.e., it is password protected and/or stored on private computer/network). Examples might include, personal web pages, e-mails files, contact information, pictures, videos, music, internet search information (e.g., bookmarks, history and favorites) and other types of content searched by Copernic Desktop search systems. The Privacy First system is designed to guard the privacy of such private content by ensuring that keywords sent over the open Internet do not disclose such private content. For example, in one embodiment, keywords are not obtained by direct or indirect examination, or algorithmic analysis of, such private content.

The first issue that must be discussed is the role of the traditional Web search ad server in the Privacy First system. It is clear that the best and highest-quality ad that can ever be served to a user is an exact match keyword ad. This means that a user types words into a search bar and those words are immediately sent to an advertising system, which then sends back the most relevant ad possible, based on those keywords.

This model raises several privacy issues. First, where those search terms are used with a private search program such as CDS, the Privacy First system does want to end such private search terms over the public Internet. Second, if we assume that e-mails represent a high percentage of all private content searches, and if we further assume that name searches represent a high percentage of all e-mail searches, then we must conclude that a large percentage of the overall searches of private desktop content will be relatively ambiguous from the perspective of the keyword advertising system. This simply means that e-mail name searches can be sent all day long to a keyword advertising system and never achieve satisfying and relevant advertising results.

In one embodiment, in order to overcome privacy obstacles and limitations discussed above, the Privacy First system includes a new relevancy technology that rigorously guards the privacy of desktop search users. One of the innovations behind the Privacy First relevancy algorithm is a separation or “firewall” between terms used to search for private content, and terms sent out over the open Internet to fetch ads. Privacy First does not send out private search terms. Instead, Privacy First uses algorithmic analysis of a dynamic public Web search terms database to deliver personalized “area of interest” ads to users.

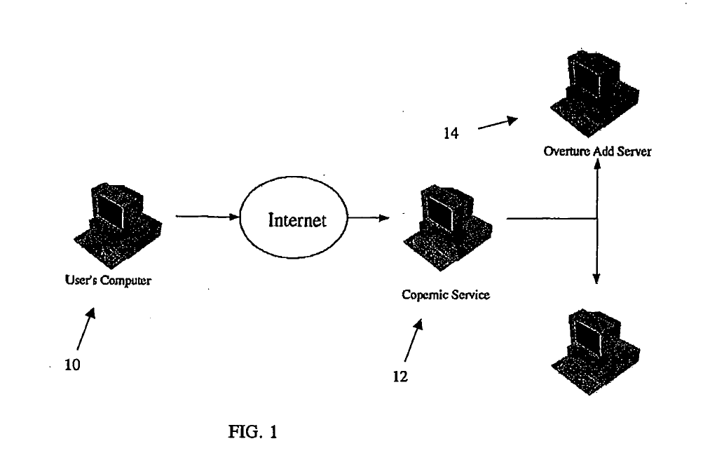

FIG. 1 illustrates one exemplary embodiment of the Privacy First system. As shown, a user's computer 10 can communicate with a digital data server 12 and/or an ad server 14. Based on a database of public search terms entered by the user, the system can rank the public search terms based on relevancy, frequency, and/or affinity. The highest ranking public search terms can be sent to the ad server 14 and used to select ads for transmission to the user's computer 10. Additionally or alternatively, as discussed below, other information such as content-type information, category-type information or distribution information can be used to select ads.

Users understand and have come to accept the fact that Web search terms entered into any major public search engine bar and subsequently sent out over the Internet to a Web or ad server have a high degree of public exposure, and in fact, have become virtual public information. Technically, from a purely quantitative perspective, this is true, as such Web search terms can be legally monitored by the ISP, and government agencies, and illegally monitored by any number of snoopers. However, it is also true from a qualitative perspective, as users will readily acknowledge that without knowing the exact details of the enabling technologies involved they believe that any such Web search terms might be viewed by other entities. While accepting as they may be about others viewing their public Web search terms, users are just the opposite, and are very emotional about the use of their private content. They believe that these private content search terms are secure on their PC, and must never be exposed to the public Internet in the same way in which their search terms of Web content are exposed during the Web search process.

At the same time, the new Privacy First system has fine tuned its approach to vertical ads, which are also now subject to the privacy policies of the Privacy First system. Distribution partner or syndicates of potential distribution partners will have the opportunity to come forward with targeted pay for performance advertising. Targeting can occur across multiple dimensions. For example, advertisers may target based on content type, i.e. my web pages, files, e-mails, pictures, images, video, favorites, history, and contacts (e.g., the type of program rather than the private information stored in the program). Some of these content categories offer the opportunity for extremely vertically targeted ads, such as pictures, videos, music and contacts. Others such as e-mail and files are far more horizontal.

Another way we can target vertical advertising is by distribution partner. For example, each of our distribution partners has an understanding of its own particular demographics. Users who download a version of Copemic Desktop Search from Best Buy may be interested in ads that are very different than users who download Copemic Desktop Search from portals or from a telco company such as Verizon. The new Privacy First system allows our distribution partners to select the logical flow of the advertising algorithm across each Copernic Desktop Search content type and/or distribution partner.

At one extreme, a distribution partner could decide to never use the Privacy First relevancy algorithm, and only to display its own vertical ads, or vertical ads based on its own advertising syndicate. At the other extreme an advertiser could decide never to display vertical ads and to completely rely on the Privacy First relevancy algorithm. The most likely case is that distribution partners will choose a hybrid model in which they will select vertical ads across some of the more highly targeted categories and some mixture of vertical and Privacy First relevancy algorithm ads across the more heterogeneous categories such as e-mails, files, history, and favorites.

Privacy First, in one embodiment, keeps a database on the user's PC of public search terms that are sent out across public Web search engines over the public Internet from a user's computer. To that 100% of the content collected is comprised of public Web search terms. For example, Privacy First can restrict its tracking to a “white” list consisting of the top publicly acknowledged Web search engines. This keyword database, in one embodiment, is not sent out over the Internet or to any central location. It is only used by Privacy First relevancy algorithm to determine the best possible “area of interest” ad to be served to the user at any point in time.

When a user searches his private CDS content, Privacy First will look in its workflow database and determine whether to serve a content category ad and/or an ad based on the Privacy First relevancy algorithm.

If a content category is chosen, then Privacy First can send to its central category ad server a secure coded distribution identification number indicating the distribution partner from which the user downloaded the particular version of CDS. This source may be Copernic.com, a portal, an e-commerce company, or if any one of Copemic's CDS distribution channel partners. In addition, or alternatively, Privacy First will send to the central CDS ad server a code indicating, which of the CDS content categories is currently being searched.

So for example, if a user gets his software from Best Buy, and searches for music with a private search program (e.g., searches music files and/or the name of a band), Privacy First system can send two pieces of information to the category ad server. For example, the Privacy First system will send out category=music and distributor=Best Buy. Note that in this case, Privacy First has not sent any private keyword information (e.g., the actual search term) or private user information (e.g., what music files are contained on the user's computer), over the public Internet, even though the user may have typed in the specific name of a musician, band, or song in the CDS music category. The CDS ad server will respond to this Privacy First information by sending a vertical category ad chosen by the distribution partner back to the user. A specific example of user interaction might be that a user searches for the term Britney and receives a “buy one CD get one free” ad good for the next week from Best Buy. Clearly in this case, we have given up on a potential lucrative keyword ad of Britney being sent to some central ad server. However, the Privacy First system has preserved the user's privacy by not exposing the search of his private music collection to the public Internet. Given the situation with downloading music today, we can see how many users, especially younger users, would not want to expose searches of their downloadable music collection over the public Internet.

In an alternative embodiment, it might also be the case that a distribution partner has decided to use the Privacy First relevancy algorithm for a particular content category instead of issuing a category ad. If a user was searching for Britney, the Privacy First algorithm would first look for an exact match. If the user has previously searched the public Internet for the term Britney, then we postulated that this term would flow through the Privacy First filter and be sent directly to the exact match advertising engine. Therefore, to the extent that the user had done Web search for the same terms that were being used to search his private content.

However, in most cases this type of ad serving would not be enabled for the Privacy First system. The reason is the need to erect and maintain an impenetrable wall between the search terms which are used for the search of private content, and those search terms which are eventually sent out over the Internet, requesting advertising information. The exact match feature might lead users to believe that in some way shape or form a snooper could tell what terms they were using to search their private data.

The reality is, that snoopers would not have been able to tell whether the terms being sent down the wire were an exact match, or a normal selection from the Privacy First relevancy algorithm. Thus the user could have been searching for “Lexus” in his private data, and drawn a “Red Sox” ad since he had been searching for “Red Sox” frequently and recently during the baseball playoffs. However, even the appearance of any correlation between private content search terms and the resulting ads displayed would have weakened the Privacy First user's bond of trust, and the foundations of its marketing positioning, and this should be avoided. In addition, demonstrations of the product where a user typed in the keyword “Lexus” might have immediately resulted in an ad for “Lexus” if we had implemented the exact match a bonus or ranking system within the Privacy First relevancy algorithm.

To overcome this limitation (i.e., not sending out exact matches of private search terms), the Privacy First system can instead use dynamic and/or static techniques to choose the best possible public Web search terms at that moment in time, and sends that public keyword or set of keywords to the ad server.

Over time, the Privacy First public keyword database will grow, and as it does, the ability of Privacy First to generate relevant ads based on the database will increase. Privacy First automatically subjects the words in the keyword database to a number of algorithms, each of which generates some level of bonus score for every search term or phrase. We will now discuss some of the various Privacy First algorithms and how they might effect the selection of the keyword which is chosen to be sent to the advertising engine.

Recency is one of the Privacy First algorithms, and can be one of the most important. If a user has done a search for a particular term in the last few minutes (a public search), that term is assigned a higher recency score then the score used if the user has not searched for that term in more than an hour. Terms searched in the last hour are scored higher than terms searched in the last day, which are scored higher than terms searched in the last month, etc. The shape of the time versus bonus curve can be adjusted according to the needs of the user. In one embodiment, the curve non-linear and decays rapidly with time. Thus, the more recent the search term, the higher the recency bonus will be.

Another factor on which algorithms can be based is frequency. Simply put, frequency measures how often each term has been searched for, not taking into account how far back in time a particular term was searched for. Frequency is important because it indicates to Privacy First the level of interest in a particular term or area. Frequency and recency have an important interaction. It is quite possible that terms which are frequently searched for in the distant past are not very relevant to the user in the present. Examples of these types of terms are terms associated with a life event or societal events. If these events happened in the distant past, even though the search terms were very frequent, the recency algorithm would factor them down. If these events happened in the near past, and if the search terms were very frequent, then Privacy First must look to see if the frequency of such terms has fallen off dramatically. If it has, it might mean that the event itself has passed, and that the user is no longer interested in seeing ads associated with such search terms.

Another factor is Affinity. Affinity means that certain words or phrases are typically found in e-mails files or web pages containing the user's search terms. It would have been very easy for Privacy First to read through the users' e-mails, files, web pages, etc. in order to obtain such information. Products such as Blinkx, may be seen as abusing a user's privacy by performing this type of processing. For example, Blinkx will read user's e-mails and files and extract key terms and send those key terms from the user's private content over the public Internet in order to match those terms with appropriate web pages, from which keywords have been previously extracted. Conversely, Privacy First ensures that the user's private content is never read for the purposes of advertising, and that no keywords, phrases, or concepts are ever extracted from the user's private content for any purposes.

Due to its rigid privacy constraints, the Privacy First relevancy algorithm takes a much different approach to affinity. As discussed earlier, we would have loved nothing better than to be in a position to read the user's private web pages, e-mails, files, etc. and extract from them the most important keywords, concepts, and phrases. Then we could have used this information by applying it in a bonus algorithm to the public Web search keywords already contained in our Privacy First database. However, our feeling is that users would view this as an indirect use of terms used to search private data in the selection process of terms ultimately targeted to be sent out over the public Internet.

Instead of reading users' private content or tracking what users type into the browser address bar (in a private search engine), or ads that they click, on Web search results that they click on, Privacy First can use a combination of many pieces of information that are available based strictly on the user's public Web search habits. For example, in our public Web search terms database, which reflects the user's Web search habits, we not only track search terms, but we also track the date, the day of him the week, and the time of day the search occurred.

What we do with this information, and how we use it for the benefit of increasing relevancy can improve the Privacy First relevancy algorithm. For example, if we see that a user is searching for the term “pizza” every night at 11 o'clock, then we might provide a dynamic relevancy bonus to the term “pizza,” if the user is searching around that time. If we see certain search terms that historically have corresponded to the time of year, for example, “skiing” in the winter and “beaches” in the summer, then again, we can start to increase bonus amounts for those terms as that traditional time of year draws near. If we see that certain search terms are usually searched for in the day, such as “stocks,” and certain search terms are searched for in the night, such as “sex,” then we can bonus accordingly as these times approach. If we see that certain search terms are typically searched for during the week, and others are searched for almost exclusively on weekends, we can again make intelligent decisions through the allocation of bonus points on behalf of the user. We can also measure the affinity of terms for other terms with respect to both recency and frequency. So for example, if we see a correlation between the terms Lexis and BMW, then if the user starts to increase his searches of one term, we might award bonus points to the other term. As the number of search terms in the database increases, the system can be fine-tuned to deliver increased relevancy to the user.

The Privacy First relevancy algorithm can have knowledge as to which content category users are currently searching, and also, which categories they tend to search at different hours, days, months, etc. The information on content category behavior may be incorporated in some algorithmic fashion into the Privacy First relevancy algorithm and used to improve the selection of public Web search terms used to invoke advertising. In addition, the Privacy First central server will pre-process all Privacy First relevancy algorithm public term keyword requests and all requests for vertical content category ads. After pre-processing, such requests may then be sent to a third party ad server.

Since all ad requests, whether for public tern keyword based ads or content category ads, can go through the Privacy First central server, the Privacy First system can develop over time, a detailed behavioral analysis pattern of individual users, or a group of users corresponding to a distribution source, or a group of geographic users, or of course, then entire CDS user base. It is important to note that the public term based behavioral information collected by Privacy First is the same information that is stored by any centralized ad vendor such as Google or Overture. By definition, any information stored about the search habits of a user, or a collection of users, will be based only on terms used to search the public Web, and not on terms used to search the private desktop.

There is no doubt that keyword search is the best experience for the user and the best experience for the vendor and the advertiser, since the ads returned by keywords are always the most relevant and therefore have the highest click through. However, in order to have keywords, we need searches which have a high percentage of keyword content associated with them. While this may be true with Web searches, it most likely is not true with desktop searches. As we have discussed e-mail is most likely the highest percent of desktop searches, and e-mail most likely will have a high percentage of searches which do not have associated keyword content, for example searches based on names. So in this case, even if privacy was not an issue, which clearly it is, sending private content search terms for email directly to the keyword engine would not be that useful, and might in fact, not offer very good relevancy.

Another popular option is to read the user's private content, such as e-mails, files, web pages, etc. and try to dynamically extract keywords, phrases and concepts through analytical techniques. This extracted data is then sent out over the Internet to the advertising engine. First and most important, this is a violation of the user's privacy and as such is not enabled by the Privacy First system. Second, it is not clear to us at all that the resulting ad is any more relevant than an area of interest ad generated by the Privacy First relevancy algorithm and based on users' actual Web search habits.

Google Mail, for example, does not always have good relevancy. This is especially true with e-mail, which is a completely horizontal vehicle. E-mails are used for every type of communication. Because of this, a search for the word “David” across all of the user's e-mails will result in e-mails discussing every conceivable subject. Trying to extract the most relevant keywords, phrases, or concepts out of e-mails generated from a search for David is difficult indeed. It may be nearly impossible to deliver good relevancy using this method. Products such as Blinkx suffer from exactly the same problem. In the case of Blinkx the problem is actually compounded by the additional questionable relevancy obtained by using Bayesian and neural net algorithms to extract concepts from web pages.

CDS has both real time and string search capabilities that will most likely be used in email searches. A typical user behavior might be “What was the name of that guy? I know his last name began with a ‘B’” And so the user types the letter “b” into the “from” search field to see all emails that were sent to him from other users whose names have a “b” in them. Now, privacy aside, how do you monetize the keyword “b?” The answer is, you can't do it. And we might have two or three letter searches like that. We might not, in the real time case, even know when the search is done, ie, when the user is finished typing words into the search bar. The Privacy First relevancy algorithm avoids all of these problems and ambiguities.

To avoid both technical and privacy issues, Privacy First falls back on another algorithm entirely. First and foremost, we always live within the constraints of the Privacy First public terms filter, meaning that whatever we send out as a result of our processing is a term or some combination of terms from our Web search terms database. The are terms that by definition, have been entered by the user into a Web search engine bar from a site on our tracking list, and which are then sent across the public Internet. Second, based on the bonus score from its recency, frequency, affinity, and other algorithms, the term selected by Privacy First express the user's area of interest over some period of time, but not necessarily at that very moment in time. We believe that these areas of interest are extremely important, and express major demographic and psychographic qualities of the user base that are relevant at all times, and not only in the instant in time in which a user might type that term into a search box. Areas of interest express long-lasting user preferences, which can be narrowed a down over time.

The major arguments for keywords is that the ad is presented along with the search results the moment that the user hits the enter key. At that point in time, we know that the particular user is interested in that specific keyword, and so we show him an ad based on the keyword. Our argument however, is a simple one. We do not believe that just because the user has entered a specific keyword for the purposes of searching his private content, that he is no longer interested in the areas of interest that have been previously expressed, as calculated by Privacy First, by his public Web searching.

For example, let's take the user who has expressed through his public search terms that he is interested in baseball, the stock market, and music. If we could watch this user during the day, we might see if searches of his private content reflect some of these areas of interest. There is also a good chance that the user is searching through e-mails or files. Let's assume that he searches his e-mails for the term “David.” Are we can to assume that he's no longer interested in baseball, the stock market, or music? We think not. And this is the fundamental decision behind the user behavioral analysis of the Privacy First relevancy algorithm. Our decision is to focus on the longer term areas of interest and behavioral preferences expressed by users as a result of their public Web searching and leverage that to display the most relevant ads possible. The fact that the ads are not displayed at the same time the user is searching for specific private keywords does not diminish the relevancy of area of interest ads that are displayed to the user, and therefore we believe the click through on such ads will be close to that achieved by keyword ads.

We are certain however, that the relevancy delivered by the Privacy First relevancy algorithm will be better than that delivered by competitive algorithms such as Google Mail or Blinkx, which attempt to read the user's private content as a basis for delivery of advertising. We do not believe that heterogeneous material, such as e-mails or files, offers a tight enough focus to base advertising on, even when the search results being analyzed are reduced in size by an initial keyword. Remember also, that CDS shows ads on search results pages only, and does not attempt to show ads when a piece of selected content is opened in its native application.

Showing an ad inside of an individual e-mail is relatively easy since there is a high degree of focus within that particular e-mail. Users are used to ads on Web search results pages, but they don't expect to see ads once they have clicked on their selected Web search site. In the same way, we believe that users will accept text-based pay for performance ads on their private content search results pages, but that they will not want these ads to carry over once they have selected their specific piece of content and opened it up with its native application.

Showing an ad across hundreds of e-mails contained in the results of the search for “David” is a much more challenging task. In this case, we do not believe that dynamically reading all the e-mails in order to extract keywords phrases and concepts will result in relevancy which is any better than the Privacy First area of interest ads. And we are especially sensitive to the amount of processing that we can do at query time without slowing down the user's PC. Based on what we've seen from Google Mail and from the relevancy shown by our competitors when reading users' e-mails and files, we believe that Privacy First's combination of category ads based on content type, and sophisticated algorithms for determining area of interest terms contained within the Web search terms database, will deliver an overall better advertising experience to the user.

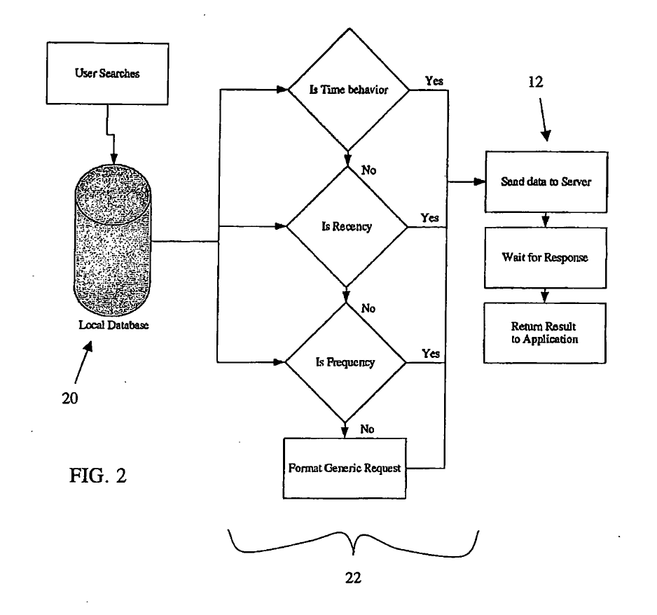

FIG. 2 illustrates a flow chart showing one embodiment of the algorithm used to select public search terms. As shown, user's search terms are stored in a database 20. The algorithm 22 then ranks and/or sorts the search terms according to time behavior, recency, and/or frequency. The highest ranking terms are sent to the digital data server 12 where the public search terms are used to select advertisements.

Hypothetical Case Studies

Our first case study is to examine a large telco or wireless company. For the purposes of our study, let's use AT&T wireless. AT&T wireless sells cell phones. Most of the sales are basic plans, say for example, $29.95 per month. Where AT&T makes all its money however, is on the high-margin items, for example cell phones which allow users to search the Internet, get e-mails, take and send images and videos, download music, etc. AT&T might therefore decide to map its vertical ads into the CDS vertical content categories. So for example, the user searching for e-mails might see an ad for AT&T's e-mail phones. If the user clicks on images, he sees an ad for AT&T's picture phones, and the video category will show ads for AT&T video capability. Music will show ads for phones which have MP3 capability. Contacts will show phones which allow users to download their Outlook contacts, and both the web and my web pages categories could show phones which are Internet enabled. Now we are left with categories such as files, history and favorites, which really do not map well on for the AT&T product suite. For these categories, AT&T might decide to fall back on the Privacy First relevancy algorithm, and if no results are available from the contracted ad server, to display a generic ad for the company or one of its products.

Our second case study involves a portal with many millions of users from all different backgrounds who are completely heterogeneous. This portal might decide to always use the Privacy First relevancy algorithm across all content categories, and never to use vertical ads. Or the portal might decide to first try Privacy First, and then fall back on vertical ads, which are reflections of its own advertisers. Of course as described above, the portal is then free to select ads which best fit the CDS content categories. The portal might also decide to have Privacy First relevancy algorithm ads in some categories, and content category ads in others.

The net result is that CDS with Privacy First offers our distribution partners a fresh, new, flexible, dynamic, and unique way of monetizing private content search traffic, keeping their brand in front of their users, and maintaining control of their own traffic. With its industry leading privacy policies, we are confident that customized, branded version of CDS will be viewed very favorably by our distribution partner's customers.

Local Relevancy Engine

The local relevancy engine is a system which allows the monetization of the local desktop while maintaining absolute privacy and security. It uses only information knowingly sent over the internet by the user. No other information is tracked or recorded. There is a strong separation between “public” terms and “private” terms. Public terms, as discussed, are terms which are already public, like search terms used in internet search engines. Private terms are anything that is used on the local desktop which has not been used publicly.

It should be noted that “what is” and “what is not” private is a matter of policy not technology. At the software level, the technology that allows one to get “public” information is the same as that used to get “private” information.

As a matter of policy “public” terms are atomic, that is that they should not be broken into smaller queries. For example “ford mustang GrT should not be reduced to “ford mustang” unless the user has already used the search term “ford mustang.” However, if the term “ford mustang” has been used as well as “ford mustang GT,” it is reasonable to use “ford mustang” when appropriate.

Most user's have habits, they look for places to eat around lunch time, they look at traffic reports around the time they go home, they look for things that interest them at night. These sorts of behaviors should show up under analysis of user search history. There should be sufficient information in the searching habits of the user that his or her needs can be anticipated. Using this habitual behavior, we can anticipate a subject in which the user will likely be interested.

Overview

The system will consist of two basic components: the desktop software and the server software. The desktop software will be designed in such a way that it can be customized for each client. The client will be able to define which algorithms are used to select relevant keywords and in what order they are executed. The server software will take the keywords sent from the desktop software.

Algorithms

The algorithms used to select relevant keywords vary based on behavioral circumstances. Each algorithm is a strategy that is used to map current user actions into past “public” information.

Behavioral Analysis

One of the more interesting algorithms is to track user's behavior. User's behavior in terms of day and time of which he or she does “public” things on the internet can be tracked. Based on the time and day that the user tends to search, it should be possible to anticipate relevant keywords based on search history.

It should be noted, with behavioral analysis, there may be enough information to anticipate the user without any action on their part. A news ticker could select relevant information and keywords based solely on day, date, and time mapped into the user's history. Time of day, this can be used to find daily behaviors like lunch plans, movies, etc. Day of week, this can be used to find weekly behaviors like weather reports or hobbies, etc. Day of month, this can be used to find monthly behaviors like financial trends, etc. Month, this can be used to find seasonal behaviors like sports teams, taxes, etc.

Recency Analysis

Similar to behavioral analysis, recency analysis tracks the users search history and anticipates relevant keywords based on most recent searches. The most recent terms out weigh older terms. Terms age non-linearly, that is they decay along a curve which accelerates with age. The curve at which a term or set of terms decay is based on the frequency at which the terms is used. If a term or set of terms is used infrequently, but fairly regularly, it will decay at a much slower rate than terms which are typically used. frequently and who's use changes suddenly.

Frequency Analysis

Similar to recency analysis, frequency analysis uses the most frequently searched terms to anticipate relevant keywords. The terms used most often out weigh terms less often. Terms age similarly to “Recency Analysis”

Term Affinity

One of the more esoteric techniques for finding keywords is to using keyword affinity. It works on the notion that the individual terms are connected. Using a good history of a user's public actions it is possible to extract “context” out of simple terms. By linking terms by their individual words and by their proximity to other terms. A person searching for lease information at the same time they are searching for automobiles, it is likely that a search for automobiles is a good opportunity to show lease information.

Product Branding

The desktop software is “branded” by the customer. Each customer will have their own brand code which will be communicated with each internet transaction and will be used to direct the best advertisements for the user as defined by the client.

The system can be built in two parts. The internet service server and the desktop software.

Internet Service:
Accepts keywords, brand codes, and other information from the client.
Where appropriate brand codes are used to direct the server
Each brand will have the option of having its own service script
Keywords that have been sent are matched against target keywords which have been either purchased by clients or passed on to third party advertisement add server
Add servers can be specified by client using an HTTP redirect
The output of the internet service is to be determined, it is likely XML to be parsed and displayed at the desktop level or rendered in HTML at the service.
The information sent to the server may be saved for further analysis.
The server may accept keywords from the desktop client software for ranking.

System

The server can be built around commodity x86 server hardware. It should be designed so that requests can be answered at a rate of 50 queries a second, giving each system a peak of 3000 queries a minute peak or 1 million queries a day assuming that most of the time it will not be operating near peak performance. (about ¼ peak performance)

The system, for example, can be a fast dual processor Linux system using a PostgreSQL database, Apache web server, and the PHP scripting language. An alternate system would be Windows Server 2003, MSSQL database, IIS, and ASP scripting language.

The disk subsystem can be 10K RPM SCSI, but fast DMA/ATA drives may be acceptable. The system should have as much RAM as possible. The RAM and the fast disk I/O is for the database. If the database resides on a separate machine from the web servers, the web servers can have moderate disk I/O and RAM.

Scaling

Scaling the system is straight forward, using multiple web servers behind a load balancer like Alteon, Cisco Local Director, or even a Linux LVS system.

The challenge is scaling the database. This can be accomplished in a couple ways known to one skilled in the art. First, we operate on the assumption that the database usage is asymmetrical and heavily weighted toward reads, i.e. There are very many more queries than updates or inserts.

Depending on the implementation and load on the system, it is not clear how much work will be done in the database. It may be that a single database can handle multiple web servers, or it may happen that the database will be the bottle neck and scaling a database for each web server makes sense.

In either case, the database scaling will be done with a single master/multiple slaves. A single master database will accept all administrative data and will push that data out to the slaves. In the unlikely event that a web server has to write to the master, a separate connection to the master database will be created and the update/insert will happen there.

If web server to master database writes become frequent, the scaling strategy will fail. If logging to the database is required, then each slave can have its own log which can be aggregated as needed. If data needs to be updated and shared by the web servers we will need to seek alternate scaling methods like full clustering of the database.

Desktop Relevancy Software
The desktop software can be a set of dynamic libraries
The API can be simple and consist of a minimal number of functions
The desktop software can call an API to add terms and data to the system
Terms inserted into the system can be evaluated and given a rank
Public terms may be sent to the internet service to assign rank.
The rank can be considered later by the various algorithms during selection.
The desktop software can call an API to retrieve information from the relevancy system
The algorithms used and the order in which they are used can be defined by the client.
Starting with the first algorithm, each algorithm can be tried successively until one returns valid information in the form of a public term.
The public term will be sent to the internet service server along with the brand code, user ID, and method by which the public term was chosen
The result of the internet query can be passed back to the desktop software
If a term is sent to the server and the server returns no data, that term's rank can be reduced making it a less likely choice next time.
Each algorithm created for the relevancy system can be a self contained shared library.
All information collected by the system can be usable by all algorithm modules.
   One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A system for privatizing personal information, comprising:
a user's computer connected to the world wide web, the user's computer adapted to recognize and collect public search terms entered into a public search program through the user's computer, the user's computer further comprising a database including the public search terms entered into the public search program and a list of category codes;
a digital data server connected to the user's computer through the world wide web and adapted to communicate therewith, the digital data server adapted to receive public search terms and/or category codes from the database; and
an ad server in communication with the user's computer and adapted to choose and send ads to the user's computer based on received public search terms and/or category codes.

2. The system of claim 1, wherein the database stores distribution information that includes the location at which the desktop search program was obtain by the user.

3. The system of claim 2, wherein the ad sever contains a database of distribution information and ads associated with the distribution location, such that the ad server can receive distribution information and chose an ad to send to the user based on the distribution information.

4. The system of claim 1, wherein the database contains information on the time of day at which the public search terms where entered into the public search program.

5. The system of claim 1, wherein the database includes private search terms entered into a desktop search program and category codes corresponding to private search terms.

6. The system of claim 1, wherein the database includes private search terms entered into a desktop search program and public search terms corresponding to the private search terms.

7. The system of claim 1, wherein the digital data server and ad server are located in separate computers connected via the world wide web.

8. The system of claim 1, wherein the ad server includes a database containing category codes and digital ads corresponding to the category codes.

9. The system of claim 1, further comprising multiple user computers in communication with the ad server.

10. A method for selecting digital ads while privatizing personal information, comprising the steps of:
collecting and storing, with a digital data processor, public search terms entered by a user into an internet based search program and date and time information corresponding to the public search terms;
ranking the search terms according to relevancy, frequency, and/or affinity based on the collected information; and
sending advertisements, with an ad server, to the user's computer based on the highest ranking search terms.

11. The method of claim 10, further comprising the step of collecting and storing, in a computer database, private search terms entered by a user into a desktop search program.

12. The method of claim 11, further comprising the step of matching the private search terms to category codes and sending the matched category codes to the ad server.

13. The method of claim 10, further comprising the step of matching a type of program used by the user to a category code and sending the matched category code to the ad server.

14. The method of claim 10, further comprising the step of creating a user profile based on the public search terms and the corresponding date and time information.

15. The method of claim 14, further comprising sending ads to the user's computer based on the user profile.

16. A method for sending ads to a users computer without revealing private information, comprising the steps of:
storing, in a computer database, public search terms entered by a user into an internet based search program and storing date and time information corresponding to the public search terms;
storing, in the computer database, private search terms entered by a user into a desktop search program and storing category codes that correspond to the private search terms;
looking up the category codes with a computer processor and sending the category codes to an ad server; and
sending ads, with an ad server, to the user's computer based on received category codes.

17. The method of claim 16, further comprising storing distribution information in the database.

18. The method of claim 17, further comprising sending the distribution information to the ad server and the ad server choosing ads based on the distribution information.
